(19) United States
(12) Patent Application Publication
(10) Pub. No.: US 2009/0008459 A1
(43) Pub. Date: Jan. 8, 2009

(54) Person Recognition Securement Method and Device

(75) Inventor: Jean-Francois Mainguet, Grenoble (FR)

Correspondence Address: FISH & RICHARDSON P.C., PO BOX 1022, MINNEAPOLIS, MN, 55440-1022, US

(73) Assignee: ATMEL GRENOBLE S.A., Saint Egreve (FR)

(21) Appl. No.: 10/542,658

(22) PCT Filed: Jan. 16, 2004
(86) PCT No.: PCT/FR2004/000092

§ 371 Date: Apr. 2, 2008

(30) Foreign Application Priority Data
Jan. 21, 2003 (FR) 03/00594

(51) Int. Cl. G06K 19/06

(52) U.S. Cl. 235/492

(57) ABSTRACT

The invention relates to person authentication systems. The invention proposes incorporating on a chip card intended to be used in a conventional card reader a sensor for spectral information relating to the skin of the person holding the chip card between his thumb and index finger. Spectral recognition uses light-emitting diodes and photodiodes mounted on a flexible substrate comprising interconnecting tracks between the light-emitting diodes and photodiodes on the one hand, and a processor contained in the chip of the chip card on the other hand.

The invention relates to chip-card-based securement devices, intended for applications in which a high level of security is required as a safeguard against the risks of fraud.

The chip card can be used to validate numerous operations through its identification system incorporated in its microprocessor. The most widely used technique for verifying that its holder is indeed its owner is authentication by a four-digit code (the PIN, or “personal identification number”). This technique offers the great advantage of requiring very little in the way of computation resources, because it entails a simple binary comparison, and the encryption techniques for securing the interchanges with the outside world have been known for a long time.

The big problem with protection based on four digits, and by extension on any password, is that it identifies only information known to the person (and information held by the person since he is presenting a chip card), but not the person himself. Biometric techniques for identification by fingerprints, by voice, facial, iris recognition, etc., overcome this problem and make fraud significantly more difficult since they are based on recognition of the person himself.

The biometric techniques require a sensor for entering the biometric information (for example, a camera for entering an image of the face), a reference which is stored in the memory of the chip card to avoid any forgery, and a processor to make the comparison between the reference and the information entered via the sensor.

Incorporation of the sensor and of all the computations directly on the chip card has already been proposed but, unfortunately, there are a number of obstacles hampering such incorporation:

the sensor is often too thick for a standard chip card. For example, a camera requires optics that are incompatible with the thinness of the card,

the sensor is often too big for the chip card: no question of capturing a palm print, for example,

almost all the biometric techniques require major computing power, not compatible with the acceptable waiting time for a user. It is essential not to exceed a few seconds of waiting time, although with the computing powers available on the chip card, computation would take a few minutes.

If the biometric sensor is placed on the chip card, then it is essential to be able to enter the biometric information when the card is inserted in the reader, or before its insertion, or to use a contactless card, but then serious power supply problems arise, because the card must be independent and therefore have its own battery. For contactless cards, with energy transmission by radiofrequency radiation, the power collected by the radiation is far too weak for a biometric sensor. It is therefore desirable to use a biometric technique which allows the biometric information to be captured when the card is inserted.

To save on memory space, it is desirable for the reference stored on the card to be as small as possible. A PIN code occupies fewer than 4 bytes.

Ideally, the sensor should also be capable of detecting fakes. For example, in the case of fingerprints, it is desirable to detect whether it is a living finger that is being detected, and not an amputated finger or dummy finger.

A recognition technique based on the shape of the cardiac pulse has already been proposed, but its performance—which will not be as precise as in the case of fingerprints—has not yet been proven, and there has been no practical implementation to date.

Detection of the blood (pulse, hemoglobin oxygen content) by optical means commonly used in medicine (infrared LED of suitable wavelength+photodiode) appears to offer an interesting solution, but will be deceived by a film of plastic material placed on a real finger, even by a plastic material having the right “color” in the infrared for a simple system. Furthermore, it is essential to wait for at least one full heartbeat, which can be fairly lengthy in the case of certain sports people, and therefore not very convenient.

In US patent proposal 2002/0009213, a technique for the spectral analysis of the skin, and more specifically the dermis of certain parts of the body, is proposed.

It involves lighting the skin with several light-emitting diodes (LED) of various colors, and analyzing the light transmitted by the skin at various distances, using a few photodiodes to measure its characteristics: the greater the distance between the light emitter and the sensor, the more depthwise characteristics of the dermis are obtained. Moreover, certain frequency bands (toward the infrared) are very sensitive to the presence of blood. The number of photodiodes and LEDs will be limited by the fact that they have to be assembled individually, and therefore the associated cost increases very quickly.

According to the invention, it is proposed to incorporate, on a chip card intended for use in a conventional card reader, a sensor for spectral information relating to the skin of the person holding the chip card between his thumb and index finger, in order to authenticate the person holding the card.

Spectral recognition requires light-emitting diodes (LEDs) and photodiodes, which will be mounted, individually (or in small groups), on a flexible substrate in order to preserve the flexibility of the assembly. This substrate will include electrical tracks providing the interconnection between the light-emitting diodes and the photodiodes on the one hand, and a processor contained in the chip of the chip card on the other hand. This substrate will be compatible with the encapsulation techniques of the chip card, leaving the LEDs and photodiodes visible (or using a transparent material).

Spectral recognition of the skin requires reduced computation power (an 8-bit processor is sufficient), and the size of the reference is small: all this is compatible with the technologies currently employed. The electronics for processing spectral information in order to authenticate or to identify a person will be contained in the chip card and the card will issue the recognition or identification information.

Advantageously, both sides of the chip card will be used to acquire the biometric information: it will be possible to measure simultaneously the spectral characteristics of the thumb and the index finger, the card being held between these two digits at the time of its insertion in a conventional chip card reader. This will make counterfeiting that much more difficult. Furthermore, in the case of intense lighting, in particular sunlight, at least one of the sides (the bottom side, facing the ground) will be in the shade, and can therefore definitely operate.

If the card has its own energy resources, it will be possible to have the spectral information captured just before insertion in the reader. It is advantageous to provide on the card means for detecting the gripping of the card between the thumb and the index finger in order to start this acquisition. If the card does not have its own energy resources, the card reader must provide them.

It is preferable to use the spectral band sensitive to hemoglobin, in the infrared, to ensure that the finger is living. It will also be possible to add a cardiac pulse measurement to make the assembly more robust against counterfeiting, as well as a measurement of the oxyhemaglobin rate. It will then be necessary for the user to hold the card for at least as long as it takes to make a measurement, or two or three heart beats.

The light-emitting diodes required to light the skin can emit at different wavelengths in visible or near infrared light, preferably including a wavelength in the absorption band of blood.

Authentication can be complemented by other devices and, in particular, a fingerprint recognition by a sensor also provided on the chip and disposed alongside the spectral information capture means so as also to be placed under a finger when the card is held in the hand.

Other characteristics and advantages of the invention will become apparent on reading the detailed description that follows, which is given in reference to the appended drawings in which:

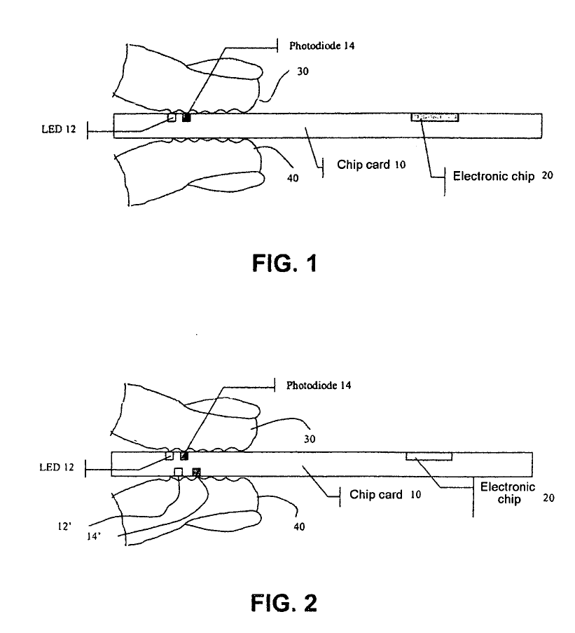

FIG. 1 represents a device according to the invention;

FIG. 2 represents an embodiment variant;

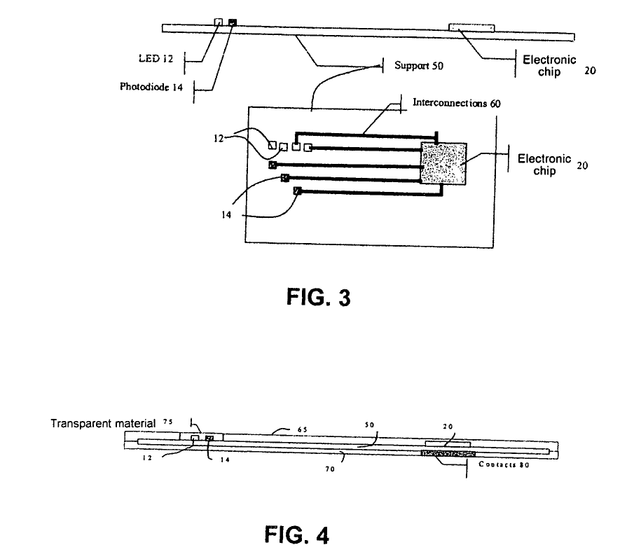

FIG. 3 represents a fabrication step of the chip card;

FIG. 4 represents the finished chip card.

FIG. 1 shows a chip card 10 of standard size, a few centimeters long and a few tenths of a millimeter thick, held in practice between the thumb 30 and the index finger 40 of a person using the card in a reader that is not shown.

The card conventionally includes a silicon electronic chip 20, capable of executing a number of signal processing functions related to the card reader; electrical contacts are in principle provided on the card for communication with the reader; however, cards supporting contactless communication with the reader also exist, and the contacts are not therefore represented in FIG. 1.

To be inserted in a card reader, the card is held between the thumb and the index finger in a place that has no contacts.

In FIG. 1, the side that has the contacts is the right side of the figure and the side on which the card is held is the left side. A visible mark is preferably provided on the card to indicate the place at which the card must be held between the thumb and the index finger. According to the invention, the chip card includes, in this position, a device comprising a sensor for spectral information relating to the skin of at least one of the two digits holding the card. This sensor in practice comprises at least one light-emitting diode (LED) 12 lighting the digit and at least one photodiode 14 capable of supplying an electrical signal representing the fraction of light received on the photodiode 14 from the LED 12 after passing through the skin and diffusion in the skin.

Preferably, the card includes a number of LEDs and a number of photodiodes; the LEDs preferably emit at a number of wavelengths, to allow for the construction of a kind of spectral print characteristic of the individual holding the card in his hand.

The LEDs and the photodiodes needed to capture this spectral print are inserted in the thickness of the card. These electronic elements will be soldered or bonded on a support, preferably flexible, electrically interconnected by link wires to the chip 20 of the chip card: the chip is normally located in the card, directly above the contacts of the card when there are contacts.

The electronic chip 20 of the card comprises a microprocessor for controlling the LEDs, reading the information sent by the photodiodes light by the LEDs, analyzing this information and performing the computations needed to verify the match between the spectral information received and the pre-stored spectral print data relating to the person holding the card.

Some of the computations concerning the identification of the person can be performed outside the chip card, the card then simply sending data concerning the detected print. This solution is, however, less satisfactory from the security point of view.

A notable enhancement of the level of recognition and security will be achieved by placing LEDs and photodiodes on each side of the chip card. When the card is held, normally between the thumb and the index finger, it will be possible to read the spectral information on each side, and at least on the shaded side (the underside) in the case of intense lighting.

FIG. 2 represents the configuration of the chip card in this case, with LEDs 12 and photodiodes 14 on the top side of the card and LEDs 12′ and photodiodes 14′ on the bottom side of the card.

In the case of FIGS. 1 and 2, the photodiodes will be implemented separately from the silicon chip, but it will be understood that it would also be possible to have the photodiodes integrated on the silicon chip in as much as the LEDs emit at wavelengths that silicon is capable of detecting, which is the case between the near ultraviolet and the near infrared. In this case, the chip is not positioned in the same place as the standard contacts of the chip card but in the place where the card is held. It is linked to the contacts (in the case of a card with contacts) by electrical connections embedded in the plastic material of the card.

The light emission by the LEDs is preferably in the red and the near infrared, for which there is a good penetration of the light inside the skin.

Capturing the spectrum of the skin consists in practice in measuring the optical response of the skin to a light excitation for different optical wavelengths. It is essential to avoid measuring the light directly reflected by the surface or the surface layers of the skin (stratum corneum). In practice, the information specific to each individual is located more in the structure of the dermis. It is therefore essential for the light emitter (LED) to be separate from the light sensor (photodiode) so that only the light that passes through the skin reaches the sensor, minimizing the fraction of light which can come directly or after simple reflection on the skin from the LED to the sensor. The choice of the distance between the light emitter and detector can be used to limit the effect of direct reflection.

The LEDs will preferably be controlled directly using the silicon chip 20 which can contain all the electronics needed to detect the print and detect spectral information.

The person recognition algorithm can also be incorporated on the silicon chip, which will make the system even less expensive. This algorithm will more often than not consist in comparing spectral measurements currently being performed with a set of pre-stored spectral measurements, associated with an individual (simple comparison for checking identity) or a number of individuals (multiple comparison for identifying one person from several).

This technique can be used with LEDs above and below the card either to double the measurements and thus increase the recognition performance, or, for example, half the LEDs can be placed above and the rest below, with measurements taken simultaneously in order to reduce the time to read the spectral print. Since the reading time is already very short, it will be preferable to double the measurements to make the assembly more resistant to counterfeiting.

In order to check that the object being measured is indeed a living finger (not a dummy latex finger, nor an amputated finger), it will be preferable to perform at least one measurement in the absorption band of blood (infrared), a measurement that will have a significant weighting in acceptance of the identification. At least one LED emitting at a wavelength in the absorption band of blood will be used.

It will also be possible to measure the pulse and the oxygen content in the blood, but it will then be necessary to accept the need to hold the chip card for a few seconds, the time needed to make the measurement, which will be less convenient for use.

Spectral recognition performance is not as good as fingerprint recognition performance, for example. In the case of a chip card, in practice, it concerns primarily making the authentication in the verification mode, that is, the aim is simply to check the holder of the card, and not in the mode of identifying one individual from several individuals whose characteristics are stored in a database. The performance characteristics should be sufficient for an average level of security, but if a very high level of security is required, then it will be necessary to add another verification element.

The spectral print will then be combined with the fingerprint, and more specifically, the scanning technique which gives high recognition rates, or voice recognition or any other form of biometry. Static or scanning-based fingerprint capture can, in particular, use an optical, thermal, capacitive or pressure sensor. The additional authentication means is preferably on the card, but it can also use signals originating from outside the card.

The fingerprint will be preferred as the additional authentication means because, since the finger is already in contact with the chip card, the capture of the fingerprint can be performed at the same time on the card, but this will require greater computation resources and the addition of a sensor, which could, if necessary, include the photodiodes.

To implement the invention, the set of elements involved in spectral print capture, and the elements involved in the additional biometric techniques, as well as the battery in the case of a card having a certain independence, can be assembled on a flexible support (flex) 50 comprising interconnecting lines 60 between the elements. This flexible support will then be sandwiched in the plastic material forming the chip card.

FIG. 3 represents, seen sideways on and from the top, the support 50 before it is enclosed between two sheets of protective plastic material.

FIG. 4 represents the finished chip card, with its external contacts 80.

The various elements will be disposed so as to allow a final flexibility that is compatible with the chip card standards. In particular, they will not be placed too near to each other. The LEDs 12 and the photodiodes 14 will be disposed so as to allow natural placement in the grip formed by the two digits.

In the case where an LED is reserved as a function indicator for the user, for example to indicate that the operation is finished positively (green) or negatively (red), it will be placed outside the card holding area. This LED, and where appropriate other indication LEDS, is controlled by the chip in conjunction with the person authentication operations.

Appropriate printed markings will be provided on the card to show the positioning of the digits and the indicator LED.

The interconnections can be disposed on both sides, with vertical conductive vias to link the top and the bottom, or even connections on the support wafer.

The two sheets of plastic material 65 and 70 which will be bonded to the support can have openings provided in line with the LEDs and photodiodes, so that they can be filled in later with a transparent material 75 (glue, transparent resin).

A variant of this embodiment consists in incorporating photodiodes in the electronic chip, and placing the chip under the position provided for the digits, near to the LEDs. This reduces the number of electronic elements and therefore costs.

1. A chip card comprising: a sensor for spectral information relating to the skin of the person holding the chip card between his thumb and index finger in order to authenticate the person holding the card.

2. The chip card as claimed in claim 1, wherein the sensor comprises at least one light-emitting diode and one photodiode.

3. The chip card as claimed in claim 2, wherein the light-emitting diodes and the photodiodes are mounted on a flexible substrate comprising electrical interconnecting tracks between the light-emitting diodes and the photodiodes on the one hand and the card chip.

4. The chip card as claimed in claim 3, wherein the flexible substrate is inserted between two sheets of plastic material, a transparent window being provided above the light-emitting diodes on the one hand and the photodiodes.

5. The chip card as claimed in claim 2, comprising light-emitting diodes and photodiodes on either side of the card to perform spectral recognition on the two digits holding the card.

6. The chip card as claimed in claim 2, wherein at least one light-emitting diode emits in an absorption spectral band of blood.

7. The chip card as claimed in claim 2, wherein it furthermore comprising one of means of measuring the cardiac pulse and means of evaluating the oxyhemaglobin rate, in order to enhance the authentication of the person.

8. The chip card as claimed in claim 2, wherein it comprising light-emitting diodes emitting at different wavelengths.

9. The chip card as claimed in claim 1, wherein it comprising at least one photodiode incorporated in the chip.

10. The chip card as claimed in claim 1, wherein the chip comprising electronic means of processing spectral information from the sensor, to allow authentication of the person holding the card.

11. The chip card as claimed in claim 1, wherein the chip comprising a memory containing stored biometric data relating to the card holder.

12. The chip card as claimed in claim 1, furthermore comprising means for detecting the holding of the card between the thumb and index finger to start the acquisition of spectral information by the sensor.

13. The chip card as claimed in claim 1, comprising other means of authenticating the person, to enhance the security of the authentication process, these means being on the card or using information originating from outside the card.

14. The chip card as claimed in claim 13, wherein the additional authentication means is a static or scanning-based fingerprint sensor, in particular optical.

15. The chip card as claimed in claim 1, comprising at least one light-emitting diode controlled by the chip, to provide visual information relating to the authentication operation.

16. The chip card as claimed in claim 3, comprising light-emitting diodes and photodiodes on either side of the card to perform spectral recognition on the two digits holding the card.

17. The chip card as claimed in claim 3, wherein at least one light-emitting diode emits in an absorption spectral band of blood.

18. The chip card as claimed in claim 3, wherein it furthermore comprising one of means of measuring the cardiac pulse and means of evaluating the oxyhemaglobin rate, in order to enhance the authentication of the person.

19. The chip card as claimed in claim 3, wherein it comprising light-emitting diodes emitting at different wavelengths.

20. The chip card as claimed in claim 2, furthermore comprising means for detecting the holding of the card between the thumb and index finger to start the acquisition of spectral information by the sensor.
